(19) United States
(12) Patent Application Publication
(10) Pub. No.: US 2026/0154219 A1
(43) Pub. Date: Jun. 4, 2026

(54) INTERFACE CIRCUIT AND SEMICONDUCTOR INTEGRATED CIRCUIT

(71) Applicant: Socionext Inc., Kanagawa (JP)

(72) Inventors: Keisuke KASUGA, Kanagawa (JP); Ryuji KOJIMA, Kanagawa (JP)

(21) Appl. No.: 19/458,155

(22) Filed: Jan. 23, 2026

Related U.S. Application Data
(63) Continuation of application No. PCT/JP2023/029215, filed on Aug. 10, 2023.

(51) Int. Cl. G06F 13/36

(52) U.S. Cl. CPC G06F 13/36; G06F 2213/40

(57) ABSTRACT

An interface circuit includes: a transmission and reception circuit being a circuit configured to transmit and receive serial data, the transmission and reception circuit having a plurality of internal states, the transmission and reception circuit configured to operate by performing a state transition between a plurality of the internal states; a control circuit configured to output, in time-series order, an internal state signal that indicates a current internal state among the plurality of internal states; and a monitor circuit including a storage circuit having a plurality of storage areas for holding the internal state signals output in time-series order, the monitor circuit configured to monitor an internal state of the transmission and reception circuit, in which the monitor circuit is configured to sequentially receive the internal state signal from the control circuit and write the received internal state signal to the plurality of storage areas in time-series order.

### CROSS-REFERENCE TO RELATED APPLICATION

This application is a continuation application of International Application PCT/JP2023/029215 filed on Aug. 10, 2023, and designated the U.S., the entire contents of which are incorporated herein by reference.

### FIELD

The embodiment discussed herein is directed to an interface circuit and a semiconductor integrated circuit.

### BACKGROUND

Patent Document 1 has described a serial data receiving device that converts serial data to parallel data and receives the data, and detects error information in the serial data. A receiving buffer is a first-in, first-out receiving buffer that temporarily stores the parallel data and the error information. A register holds the error information. The serial data receiving device includes a means for extracting error information from data read from the receiving buffer and transferring it to the register, and a means for outputting a read request for the error information held in the register only when the error information held in the register indicates occurrence of error in the serial data.

Patent Document 2 has described a data processor in which a CPU, a debugging aid module, and other circuit modules are mounted on a semiconductor chip. The debugging aid module selects an information transmitting path from a plurality of information transmitting paths used for the operation of the CPU or other circuit modules in accordance with a trace condition, holds trace information obtained according to the trace condition from the selected information transmitting path together with attribute information of the information in a buffer circuit, and enables the trace information and its attribute information held in the buffer circuit to be output serially to an outside of the semiconductor chip in a predetermined format.

Patent Document 3 has described a semiconductor device that is capable of monitoring a connection state of terminals on a semiconductor chip. A selector is configured to acquire, based on a detection signal, terminal levels of a plurality of respective terminals on the semiconductor chip to which an inspection pattern is input. A memory is configured to store, based on the detection signal, latch data based on a chip address that identifies the semiconductor chip and a plurality of the terminal levels corresponding to a plurality of the terminals. An output circuit is configured to read, based on the detection signal, a plurality of pieces of the latch data corresponding to the inspection pattern from the memory and output a plurality of pieces of the latch data. A timing control circuit is configured to generate the detection signal by detecting an edge of a clock input during an inspection mode, and activate the selector, the memory, and the output circuit.

[Patent Document 1] Japanese Laid-open Patent Publication No. 08-249257

[Patent Document 2] Japanese Laid-open Patent Publication No. 2002-149442

[Patent Document 3] Japanese Laid-open Patent Publication No. 2021-43557

In the serial data interface circuit, when debugging, it is necessary to learn not only the current internal state but also the past internal state. For example, when investigating the reason why an unintentional transmission and reception stop state occurred, understanding the internal state before the stop state makes it possible to identify the reason why the stop state occurred. However, in the case of high-speed communications, it is difficult to grasp the past internal state.

### SUMMARY

An interface circuit includes: a transmission and reception circuit being a circuit configured to transmit and receive serial data, the transmission and reception circuit having a plurality of internal states, the transmission and reception circuit configured to operate by performing a state transition between a plurality of the internal states; a control circuit configured to output, in time-series order, an internal state signal that indicates a current internal state among the plurality of internal states; and a monitor circuit including a storage circuit having a plurality of storage areas for holding the internal state signals output in time-series order, the monitor circuit configured to monitor an internal state of the transmission and reception circuit, in which the monitor circuit is configured to sequentially receive the internal state signal from the control circuit and write the received internal state signal to the plurality of storage areas in time-series order.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a semiconductor integrated circuit according to this embodiment;

FIG. 2 is a view illustrating internal states of a serial interface circuit;

FIG. 3 is a view illustrating an example of external terminals of the serial interface circuit, a monitor circuit, and a control register;

FIG. 4 is a diagram illustrating a configuration example of the monitor circuit;

FIG. 5 is a time chart illustrating an operation example of the monitor circuit when a mode signal is “*00;”

FIG. 6 is a time chart illustrating an operation example of the monitor circuit when the mode signal is “*10;”

FIG. 7 is a time chart illustrating an operation example of the monitor circuit when the mode signal is “001;”

FIG. 8 is a time chart illustrating an operation example of the monitor circuit when the mode signal is “111;”

FIG. 9 is a time chart illustrating an operation example of the monitor circuit when the mode signal is “011;”

FIG. 10 is a time chart illustrating an operation example of the monitor circuit when the mode signal is “101;”

FIG. 11 is a view illustrating an example of changes of an internal state signal;

FIG. 12 is a state transition diagram of an LTSSM;

FIG. 13 is a view illustrating an example of a trigger state signal; and

FIG. 14 is a flowchart illustrating an operation example of the semiconductor integrated circuit in FIG. 1.

### DESCRIPTION OF EMBODIMENTS

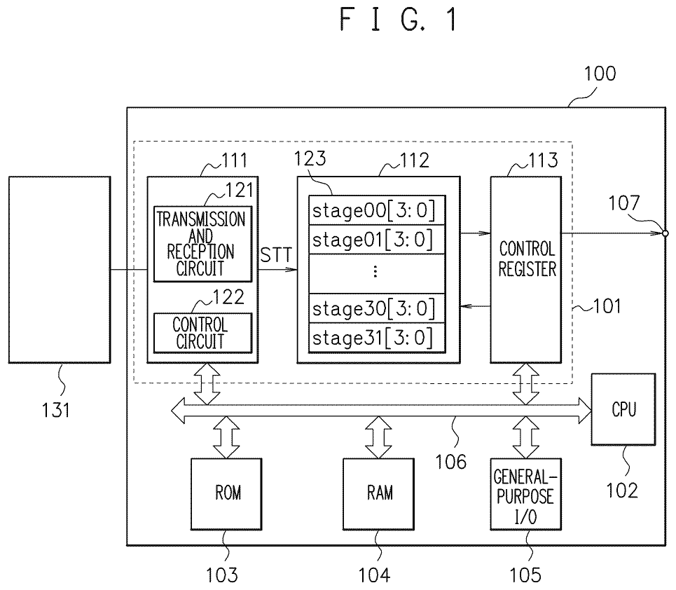

FIG. 1 is a diagram illustrating a configuration example of a semiconductor integrated circuit 100 according to this embodiment. The semiconductor integrated circuit 100 includes an interface circuit 101, a central processing unit (CPU) 102, a ROM 103, a RAM 104, a general-purpose I/O 105, a bus 106, and a debugging terminal 107.

The interface circuit 101 includes a serial interface circuit 111, a monitor circuit 112, and a control register 113. The serial interface circuit 111 is a serial interface circuit capable of performing high-speed data communication conforming to, for example, the Peripheral Component Interconnect-Express (PCIE) standard. The serial interface circuit 111 includes a transmission and reception circuit 121 and a control circuit 122.

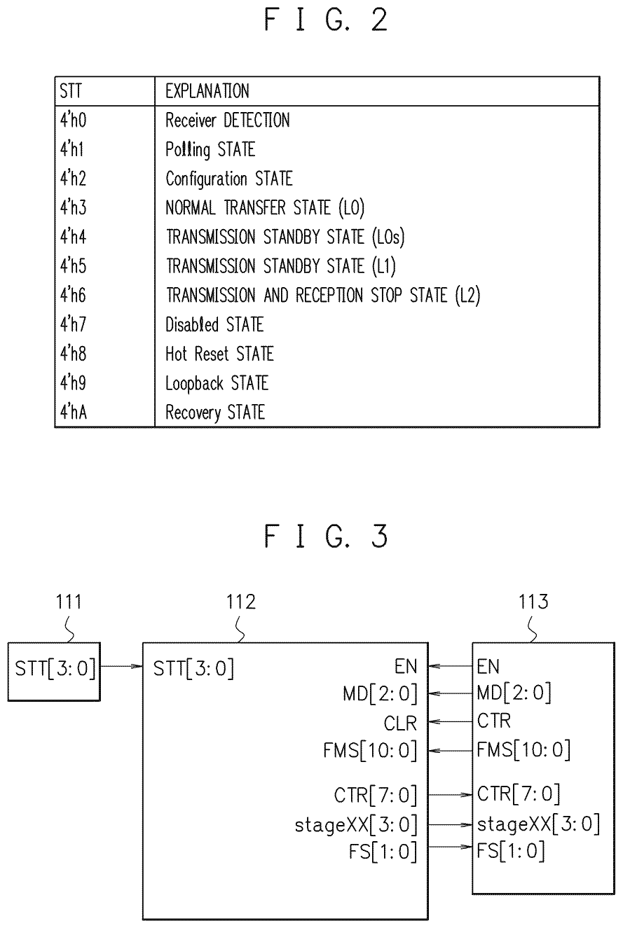

The transmission and reception circuit 121 is a circuit that transmits and receives serial data, has a plurality of internal states STT illustrated in FIG. 2, and operates by performing a state transition between a plurality of the internal states STT. The control circuit 122 outputs a 4-bit internal state signal STT[3:0] indicating a current internal state among a plurality of the internal states STT to the monitor circuit 112 in time-series order.

The internal states STT illustrated in FIG. 2 are, for example, internal states of an LTSSM (Link Training and Status State Machine), and 4-bit information is represented in hexadecimal. For example, in 4′h0, “4” represents 4-bit information, “h” represents a hexadecimal number, and “0” represents an internal state. The internal state STT has 11 internal states “0” to “A” in hexadecimal notation, for example.

The monitor circuit 112 includes a FIFO (first-in-first-out) buffer 123 having a plurality of storage areas stage00 to stage31 for holding the time-series internal state signals STT[3:0], and monitors the internal states STT of the transmission and reception circuit 121. The FIFO buffer 123 is an example of a storage circuit, and performs first-in, first-out for the internal state signal STT[3:0]. The FIFO buffer 123 has the 32 storage areas stage00 to stage31. The storage area stage00 is the first-stage storage area, and the storage area stage31 is the final-stage storage area. For example, the storage area stage007 or the storage area stage024 is an intermediate-stage storage area between the first stage and the final stage among a plurality of the storage areas stage00 to stage31.

The monitor circuit 112 sequentially receives the internal state signal STT[3:0] from the control circuit 122 and writes the received internal state signal STT[3:0] to a plurality of the storage areas stage00 to stage31 of the FIFO buffer 123 in time-series order. Internal state signals stage00[3:0] to stage31[3:0] are signals held in the storage areas stage00 to stage31 respectively.

The serial interface circuit 111 transmits and receives serial data to and from another serial interface circuit 131. The serial interface circuit 131 has the same configuration as the serial interface circuit 111.

For example, when the internal state signal STT[3:0] output by the control circuit 122 is “3,” the serial interface circuit 111 indicates to the serial interface circuit 131 that it is a normal transfer state.

Further, when the internal state signal STT[3:0] output by the control circuit 122 is “6,” the serial interface circuit 111 indicates to the serial interface circuit 131 that it is a transmission and reception stop state.

As above, checking the internal state signal STT[3:0] makes it possible to debug the serial interface circuit 111. When debugging the serial interface circuit 111, it is necessary to learn not only the current internal state STT but also the past internal state STT. For example, when investigating the reason why an unintentional transmission and reception stop state (“6”) occurred, understanding the preceding internal state STT makes it possible to identify the reason why the transmission and reception stop state occurred. The FIFO buffer 123 can hold the internal state signals STT[3:0] that indicate a plurality of time-series internal states.

The control register 113 stores a control signal for controlling the operation of the monitor circuit 112. The monitor circuit 112 writes the internal state signal STT[3:0] to the FIFO buffer 123 based on the control signal stored in the control register 113. Every time the internal state signal STT[3:0] changes, the monitor circuit 112 writes the changed internal state signal STT[3:0] to the FIFO buffer 123.

The CPU 102 is a processing circuit, and controls the serial interface circuit 111, the control register 113, the ROM 103, the RAM 104, and the general-purpose I/O 105 via the bus 106. The CPU 102 controls transmission and reception via the serial interface circuit 111.

The ROM 103 stores programs and parameters. The CPU 102 loads the programs stored in the ROM 103 into the RAM 104 and executes them, and performs various pieces of processing and controls. The RAM 104 has a working area for the CPU 102. The general-purpose I/O 105 is, for example, a USB (Universal Serial Bus) interface circuit.

The debugging terminal 107 is, for example, a jtag terminal. The control register 113 performs input and output to and from the CPU 102 via the bus 106. Further, the control register 113 can also perform input and output to and from an external device via the debugging terminal 107. In other words, the control register 113 can perform reading and writing by the CPU 102 or the external device.

FIG. 3 is a view illustrating an example of terminals of the serial interface circuit 111, the monitor circuit 112, and the control register 113. The serial interface circuit 111 has an output terminal for the internal state signal STT[3:0] to the monitor circuit 112. The monitor circuit 112 has an input terminal for the internal state signal STT[3:0] from the serial interface circuit 111.

The control register 113 has an output terminal for a write enable signal EN, an output terminal for a mode signal MD[2:0], an output terminal for a clear signal CLR, and an output terminal for a trigger state signal FMS[10:0] to the monitor circuit 112.

The monitor circuit 112 has an input terminal for the write enable signal EN, an input terminal for the mode signal MD[2:0], an input terminal for the clear signal CLR, and an input terminal for the trigger state signal FMS[10:0] from the control register 113.

The monitor circuit 112 has an output terminal for a write count signal CTR[7:0], an output terminal for the 32 internal state signals stage00[3:0] to stage31[3:0], and an output terminal for a FIFO state signal FS[1:0] to the control register 113.

The control register 113 has an input terminal for the write count signal CTR[7:0], an input terminal for the 32 internal state signals stage00[3:0] to stage31[3:0], and an input terminal for the FIFO state signal FS[1:0] from the monitor circuit 112.

The control register 113 stores the write enable signal EN, the mode signal MD[2:0], the clear signal CLR, the trigger state signal FMS[10:0], the write count signal CTR[7:0], the 32 internal state signals stage00[3:0] to stage31[3:0], and the FIFO state signal FS[1:0]. The write enable signal EN, the mode signal MD[2:0], the clear signal CLR, and the trigger state signal FMS[10:0] are examples of the control signal.

The write count signal CTR[7:0], the 32 internal state signals stage00[3:0] to stage31[3:0], and the FIFO state signal FS[1:0] are written to the control register 113 periodically in synchronization with a clock signal.

The write enable signal EN indicates that writing to the FIFO buffer 123 is permitted in the case of assertion (“1”), and indicates that writing to the FIFO buffer 123 is not permitted in the case of negation (“0”).

The mode signal MD[2:0] is a 3-bit signal. “1” of a mode signal MD[0] indicates trigger mode on, and when the write enable signal EN is asserted, writing to the FIFO buffer 123 is started, and when any of the internal state signals indicating the internal state designated by the corresponding bit of the trigger state signal FMS[10:0] is written to a designated storage area of the FIFO buffer 123, writing to the FIFO buffer 123 is finished. The above-described designated storage area is designated by a mode signal MD[2:1]. Details of the above are explained below.

In the case of the mode signal MD[2:0] being “001,” when any of the internal state signals indicating the internal state designated by the corresponding bit of the trigger state signal FMS[10:0] is written to the first-stage storage area stage00, writing to the FIFO buffer 123 is finished. The default value of the mode signal MD[2:1] is, for example, “00.”

In the case of the mode signal MD[2:0] being “011,” when any of the internal state signals indicating the internal state designated by the corresponding bit of the trigger state signal FMS[10:0] is written to an intermediate-stage first storage area between the first stage and the final stage, which is, for example, the storage area stage07, writing to the FIFO buffer 123 is finished.

In the case of the mode signal MD[2:0] being “101,” when any of the internal state signals indicating the internal state designated by the corresponding bit of the trigger state signal FMS[10:0] is written to an intermediate-stage second storage area between the first stage and the final stage, which is, for example, the storage area stage24, writing to the FIFO buffer 123 is finished.

In the case of the mode signal MD[2:0] being “111,” when any of the internal state signals indicating the internal state designated by the corresponding bit of the trigger state signal FMS[10:0] is written to the final-stage storage area stage31, writing to the FIFO buffer 123 is finished.

The trigger state signal FMS[10:0] is an 11-bit signal, and each of the bits indicates whether or not the 11 internal states STT in FIG. 2 are triggers. When each of the bits is “0,” the internal state corresponding to that bit does not become a trigger. When each of the bits is “1,” the internal state corresponding to that bit becomes a trigger. By each of the bits of the trigger state signal FMS[10:0], one or more internal states to be designated as a trigger can be set from among a plurality of the internal states STT.

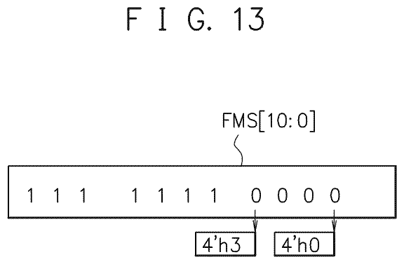

FIG. 13 is a view illustrating an example of the trigger state signal FMS[10:0]. A trigger state signal FMS[0] indicates the trigger state of the internal state STT “0.” A trigger state signal FMS[1] indicates the trigger state of the internal state STT “1.” As above, the trigger state signals FMS[10:0] indicate the trigger states of the internal states STT “0” to “A” respectively.

The monitor circuit 112 finishes writing to the FIFO buffer 123 when any of the plural internal state signals indicating the internal state designated by the corresponding bit of the trigger state signal FMS [10:0] being “1” is written to a designated storage area of the FIFO buffer 123.

“0” of the mode signal MD[0] indicates trigger mode off, and when the write enable signal EN is asserted, writing to the FIFO buffer 123 is started, and finish of writing to the FIFO buffer 123 does not depend on the internal state to be written to the FIFO buffer 123. The method of finishing writing is determined by the mode signal MD[2:1]. Details of the above are explained below.

In the case of the mode signal MD[2:0] being “*00,” when the write enable signal EN is asserted, writing to the FIFO buffer 123 is started, and when the FIFO buffer 123 becomes full, writing to the FIFO buffer 123 is finished. Here, “*” indicates don't care.

In the case of the mode signal MD[2:0] being “*10,” when the write enable signal EN is asserted, writing to the FIFO buffer 123 is started, and when the write enable signal EN is negated, writing to the FIFO buffer 123 is finished. Even when the FIFO buffer 123 becomes full, writing is continued, and the internal state signals held in the respective storage areas are updated to newer ones in sequence.

“1” of the clear signal CLR indicates a clear instruction for the FIFO buffer 123.

The write count signal CTR[7:0] indicates the number of times of writing to the FIFO buffer 123. When the write count signal CTR[7:0] becomes 0xFF, counting is stopped. When the clear signal CLR becomes “1,” the write count signal CTR is initialized to “0.”

An internal state signal stageXX[3:0] indicates the internal state signals stage00[3:0] to stage31[3:0]. The first-stage storage area stage00 is a storage area that holds the latest internal state signal STT[3:0]. As XX of the storage area stageXX becomes larger, the storage area stageXX holds an older internal state signal STT[3:0].

When the write count signal CTR[7:0] is 0x05, the storage area stage00 holds the latest internal state signal STT[3:0], and the storage area stage04 holds the oldest internal state signal STT[3:0]. The signals of the storage areas stage05 to stage31 are invalid signals.

The FIFO state signal FS[1:0] indicates the state of the FIFO buffer 123. “00” of the FIFO state signal FS[1:0] indicates a state where the write count signal CTR[7:0] is “0” and writing to the FIFO buffer 123 is not being performed.

“01” of the FIFO state signal FS[1:0] indicates a state where writing to the FIFO buffer 123 has been performed, and the case where the mode signal MD[0] is “1” indicates a state where none of the internal state signals indicating the internal state designated by the corresponding bit of the trigger state signal FMS[10:0] being “1” have been written to the designated storage area of the FIFO buffer 123.

“10” of the FIFO state signal FS[1:0] indicates that the mode signal MD[0] is “1,” and indicates a state where any of the internal state signals indicating the internal state designated by the corresponding bit of the trigger state signal FMS[10:0] being “1” has been written to a designated storage area of the FIFO buffer 123, which is a state where the FIFO buffer 123 is not full.

“11” of the FIFO state signal FS[1:0] indicates that the mode signal MD[0] is “1,” and indicates a state where any of the internal state signals indicating the internal state designated by the corresponding bit of the trigger state signal FMS[10:0] being “1” has been written to a designated storage area of the FIFO buffer 123, which is a state where the FIFO buffer 123 is full.

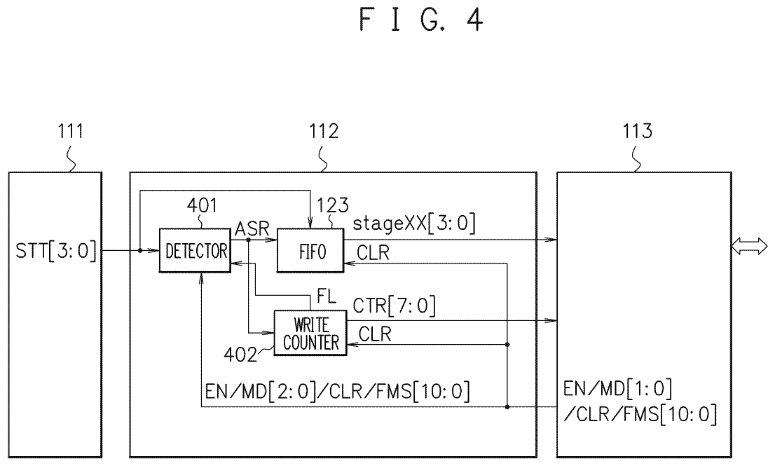

FIG. 4 is a diagram illustrating a configuration example of the monitor circuit 112. The monitor circuit 112 includes the FIFO buffer 123, a detector 401, and a write counter 402. The monitor circuit 112 receives the internal state signal STT[3:0] from the serial interface circuit 111. Further, the monitor circuit 112 receives the write enable signal EN, the mode signal MD[2:0], the clear signal CLR, and the trigger state signal FMS[10:0] from the control register 113. Further, the monitor circuit 112 outputs the internal state signals stage00[3:0] to stage31[3:0] to the control register 113.

The detector 401 asserts a state change signal ASR when the internal state signal STT[3:0] changes according to the write enable signal EN, the mode signal MD[2:0], the clear signal CLR, the trigger state signal FMS[10:0], and a FIFO full signal FL, and negates the state change signal ASR when the internal state signal STT[3:0] does not change.

When the state change signal ASR is asserted, the FIFO buffer 123 writes the internal state signal STT[3:0] to the storage area stageXX on a first-in-first-out basis. The FIFO buffer 123 outputs the internal state signals stage00[3:0] to stage31[3:0] to the control register 113. Further, when the clear signal CLR is “1,” the FIFO buffer 123 initializes the storage areas stage00 to stage31 to a predetermined value, which is all 1's or the like.

When the state change signal ASR is asserted, the write counter 402 counts (increments) a write count value (the number of times of writing) to the FIFO buffer 123 and outputs the write count signal CTR[7:0] indicating the write count value to the control register 113. The initial value of the write count value is 0. Further, when the write count value becomes “32” or more in decimal notation, the write counter 402 outputs the asserted FIFO full signal FL because the FIFO buffer 123 is full. Further, when the clear signal CLR becomes “1,” the write counter 402 initializes the write count value to 0. Further, when the write count value becomes 0xFF, the write counter 402 stops incrementing the write count value.

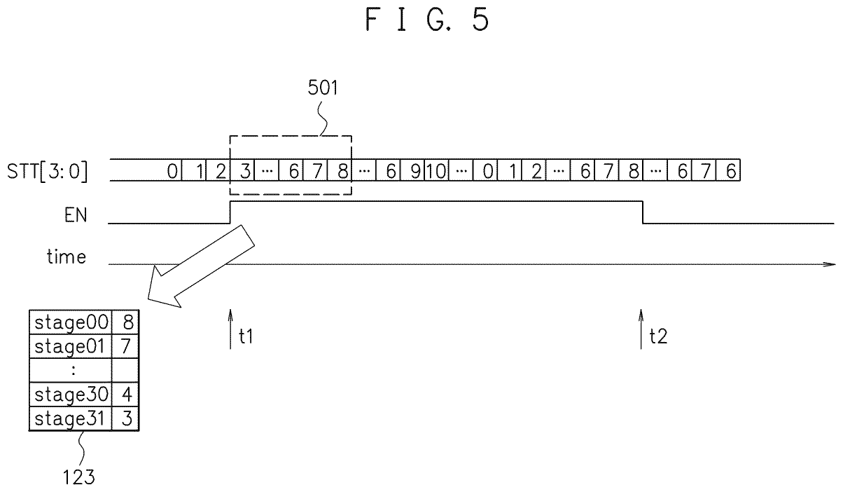

FIG. 5 is a time chart illustrating an operation example of the monitor circuit 112 when the mode signal MD[2:0] is “*00.” It is a trigger mode off state. The monitor circuit 112 starts writing to the FIFO buffer 123 when the write enable signal EN is asserted, and finishes writing to the FIFO buffer 123 when the FIFO buffer 123 becomes full.

At a time t1, the write enable signal EN changes from being negated to being asserted, and the internal state signal STT[3:0] changes from “2” to “3.” Then, the detector 401 asserts the state change signal ASR. Then, the FIFO buffer 123 writes “3” of the internal state signal STT[3:0] to the storage area stage00, and the write counter 402 increments the write count value.

Then, when the internal state signal STT[3:0] changes from “3” to “4,” the FIFO buffer 123 writes “3” to the storage area stage01, and writes “4” to the storage area stage00.

When the write count value becomes “32,” the FIFO buffer 123 becomes full and the write counter 402 asserts the FIFO full signal FL. Then, the detector 401 fixes the state change signal ASR to being negated. Thereafter, even when the internal state signal STT[3:0] changes, writing to the storage areas stage00 to stage31 is not performed. The internal state signals stage00[3:0] to stage31[3:0] are maintained as internal state signals 501. The oldest internal state signal of “3” is stored in the storage area stage31, and the latest internal state signal of “8” is stored in the storage area stage00.

At a time t2, the write enable signal EN changes from being asserted to being negated. The monitor circuit 112 outputs the internal state signals 501, and the control register 113 stores the internal state signals 501.

As above, the monitor circuit 112 stores the 32 internal state signals STT[3:0] immediately after the time t1 when the write enable signal EN is asserted in the storage areas stage00 to stage31 and outputs them to the control register 113, like the internal state signals 501.

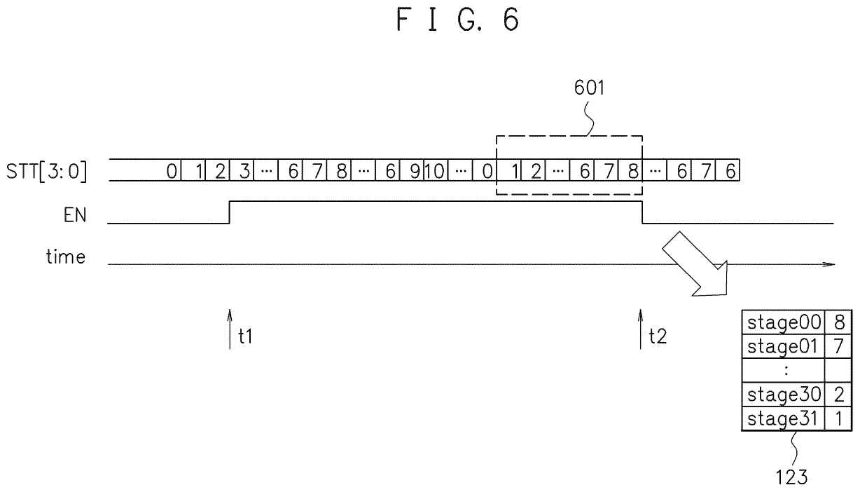

FIG. 6 is a time chart illustrating an operation example of the monitor circuit 112 when the mode signal MD[2:0] is “*10.” It is a trigger mode off state. The monitor circuit 112 starts writing to the FIFO buffer 123 when the write enable signal EN is asserted, and finishes writing to the FIFO buffer 123 when the write enable signal EN is negated.

At the time t1, the write enable signal EN changes from being negated to being asserted, and the internal state signal STT[3:0] changes from “2” to “3.” Then, the detector 401 asserts the state change signal ASR. Then, the FIFO buffer 123 writes “3” of the internal state signal STT[3:0] to the storage area stage00, and the write counter 402 increments the write count value.

Then, when the internal state signal STT[3:0] changes from “3” to “4,” the FIFO buffer 123 writes “3” to the storage area stage01 and writes “4” to the storage area stage00.

When the write count value becomes “32,” the FIFO buffer 123 becomes full and the write counter 402 asserts the FIFO full signal FL. However, regardless of the FIFO full signal FL, the detector 401 asserts the state change signal ASR when the internal state signal STT[3:0] changes. The FIFO buffer 123 continues writing according to the state change signal ASR.

At the time t2, the write enable signal EN changes from being asserted to being negated. Then, the detector 401 fixes the state change signal ASR to being negated. Thereafter, even when the internal state signal STT[3:0] changes, writing to the storage areas stage00 to stage31 is not performed. The internal state signals stage00[3:0] to stage31[3:0] are maintained as internal state signals 601. The oldest internal state signal of “1” is stored in the storage area stage31, and the latest internal state signal of “8” is stored in the storage area stage00.

The monitor circuit 112 outputs the internal state signals 601, and the control register 113 stores the internal state signals 601.

As above, the monitor circuit 112 stores the 32 internal state signals STT[3:0] immediately before the time t2 when the write enable signal EN is negated in the storage areas stage00 to stage31 and outputs them to the control register 113, like the internal state signals 601.

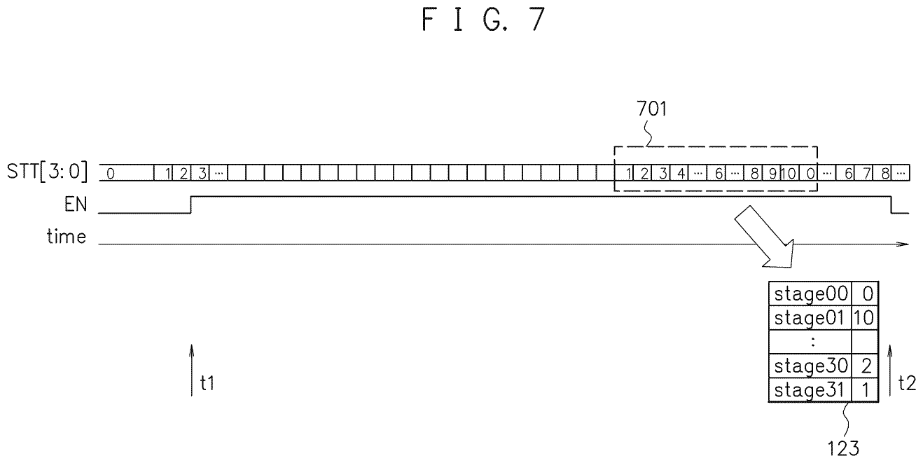

FIG. 7 is a time chart illustrating an operation example of the monitor circuit 112 when the mode signal MD[2:0] is “001.” It is a trigger mode on state. When the write enable signal EN is asserted, the monitor circuit 112 starts writing to the FIFO buffer 123. Further, the monitor circuit 112 finishes writing to the FIFO buffer 123 when any of the internal state signals indicating the internal state designated by the corresponding bit of the trigger state signal FMS[10:0] being “1” is written to the first-stage storage area stage00. FIG. 7 illustrates an example where the trigger state signal FMS[10:1] is “0” and the trigger state signal FMS[0] is “1.”

At the time t1, the write enable signal EN changes from being negated to being asserted, and the internal state signal STT[3:0] changes from “2” to “3.” Then, in the same manner as above, the detector 401 asserts the state change signal ASR, and the FIFO buffer 123 starts writing.

Then, similarly to an internal state signal 701, when “0” is written to the storage area stage00, the detector 401 fixes the state change signal ASR to being negated. Thereafter, even when the internal state signal STT[3:0] changes, writing to the storage areas stage00 to stage31 is not performed. The internal state signals stage00[3:0] to stage31[3:0] are maintained as the internal state signals 701. The oldest internal state signal of “1” is stored in the storage area stage31, and the latest internal state signal of “0” is stored in the storage area stage00.

At the time t2, the write enable signal EN changes from being asserted to being negated. The monitor circuit 112 outputs the internal state signals 701, and the control register 113 stores the internal state signals 701.

As above, the monitor circuit 112 stores “0” of the internal state signal and the preceding 31 internal state signals in the storage areas stage00 to stage31, and outputs them to the control register 113, like the internal state signals 701.

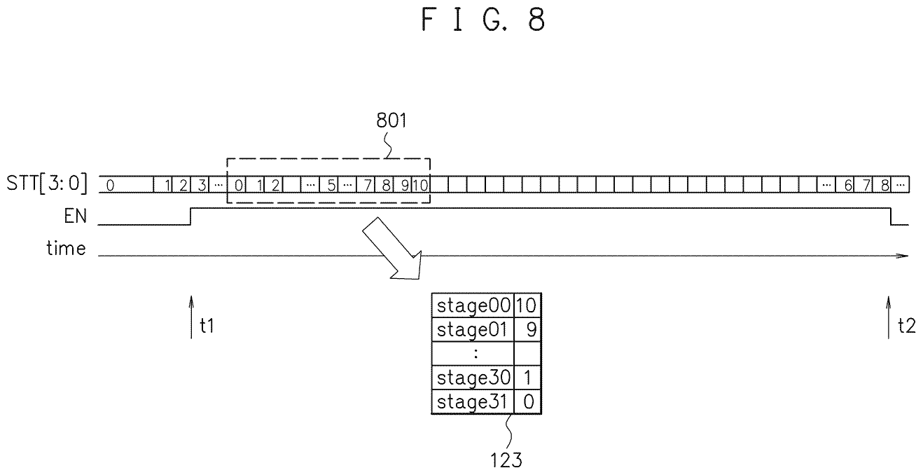

FIG. 8 is a time chart illustrating an operation example of the monitor circuit 112 when the mode signal MD[2:0] is “111.” It is a trigger mode on state. When the write enable signal EN is asserted, the monitor circuit 112 starts writing to the FIFO buffer 123. Further, the monitor circuit 112 finishes writing to the FIFO buffer 123 when any of the internal state signals indicating the internal state designated by the corresponding bit of the trigger state signal FMS[10:0] being “1” is written to the final-stage storage area stage31. FIG. 8 illustrates an example where the trigger state signal FMS[10:1] is “0” and the trigger state signal FMS[0] is “1.”

At the time t1, the write enable signal EN changes from being negated to being asserted, and the internal state signal STT[3:0] changes from “2” to “3.” Then, in the same manner as above, the detector 401 asserts the state change signal ASR, and the FIFO buffer 123 starts writing.

Then, similarly to an internal state signal 801, when “0” is written to the storage area stage31, the detector 401 fixes the state change signal ASR to being negated. Thereafter, even when the internal state signal STT[3:0] changes, writing to the storage areas stage00 to stage31 is not performed. The internal state signals stage00[3:0] to stage31[3:0] are maintained as the internal state signals 801. The oldest internal state signal of “0” is stored in the storage area stage31, and the latest internal state signal of “10” is stored in the storage area stage00.

At the time t2, the write enable signal EN changes from being asserted to being negated. The monitor circuit 112 outputs the internal state signals 801, and the control register 113 stores the internal state signals 801.

As above, the monitor circuit 112 stores “0” of the internal state signal and the subsequent 31 internal state signals in the storage areas stage00 to stage31, and outputs them to the control register 113, like the internal state signals 801.

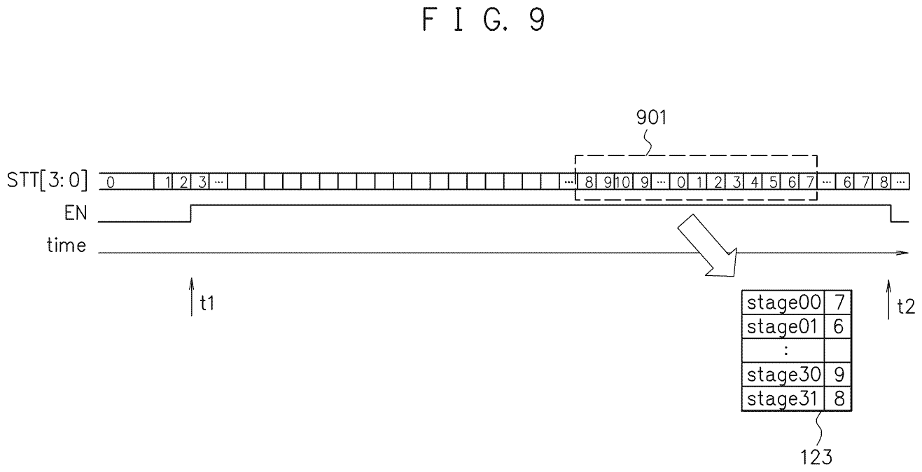

FIG. 9 is a time chart illustrating an operation example of the monitor circuit 112 when the mode signal MD[2:0] is “011.” It is a trigger mode on state. When the write enable signal EN is asserted, the monitor circuit 112 starts writing to the FIFO buffer 123. Further, the monitor circuit 112 finishes writing to the FIFO buffer 123 when any of the internal state signals indicating the internal state designated by the corresponding bit of the trigger state signal FMS[10:0] being “1” is written to the storage area stage07. The storage area stage07 is an intermediate-stage storage area between the first stage and the final stage among a plurality of the storage areas stage00 to stage31. FIG. 9 illustrates an example where the trigger state signal FMS[10:1] is “0” and the trigger state signal FMS[0] is “1.”

At the time t1, the write enable signal EN changes from being negated to being asserted, and the internal state signal STT[3:0] changes from “2” to “3.” Then, in the same manner as above, the detector 401 asserts the state change signal ASR, and the FIFO buffer 123 starts writing.

Then, similarly to an internal state signal 901, when “0” is written to the storage area stage07, the detector 401 fixes the state change signal ASR to being negated. Thereafter, even when the internal state signal STT[3:0] changes, writing to the storage areas stage00 to stage31 is not performed. The internal state signals stage00[3:0] to stage31[3:0] are maintained as the internal state signals 901. The oldest internal state signal of “8” is stored in the storage area stage31, and the latest internal state signal of “7” is stored in the storage area stage00.

At the time t2, the write enable signal EN changes from being asserted to being negated. The monitor circuit 112 outputs the internal state signals 901, and the control register 113 stores the internal state signals 901.

As above, the monitor circuit 112 stores “0” of the internal state signal as well as the subsequent seven internal state signals and the preceding 24 internal state signals in the storage areas stage00 to stage31, and outputs them to the control register 113, like the internal state signals 901.

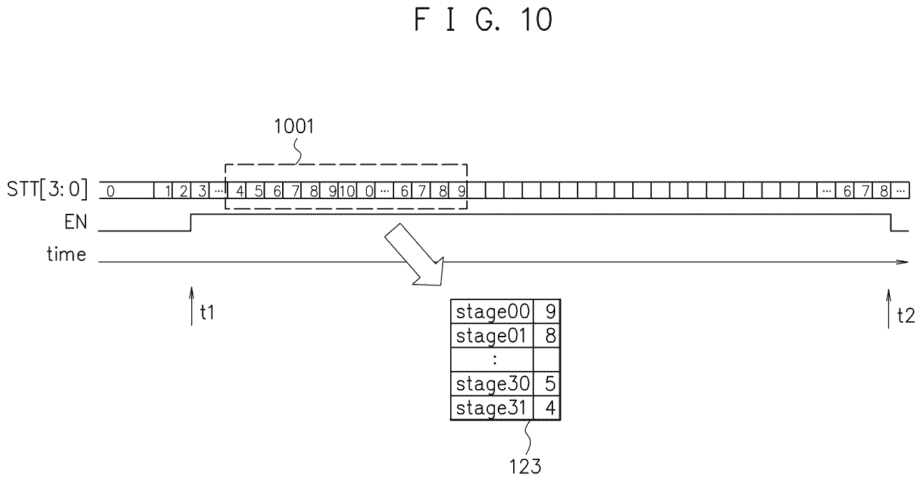

FIG. 10 is a time chart illustrating an operation example of the monitor circuit 112 when the mode signal MD[2:0] is “101.” It is a trigger mode on state. When the write enable signal EN is asserted, the monitor circuit 112 starts writing to the FIFO buffer 123. Further, the monitor circuit 112 finishes writing to the FIFO buffer 123 when any of the internal state signals indicating the internal state indicated by the trigger state signal FMS[10:0] is written to the storage area stage24. The storage area stage24 is an intermediate-stage storage area between the first stage and the final stage among a plurality of the storage areas stage00 to stage31. FIG. 10 illustrates an example where the trigger state signal FMS[10:1] is “0” and the trigger state signal FMS[0] is “1.”

At the time t1, the write enable signal EN changes from being negated to being asserted, and the internal state signal STT[3:0] changes from “2” to “3.” Then, in the same manner as above, the detector 401 asserts the state change signal ASR, and the FIFO buffer 123 starts writing.

Then, similarly to an internal state signal 1001, when “0” is written to the storage area stage24, the detector 401 fixes the state change signal ASR to being negated. Thereafter, even when the internal state signal STT[3:0] changes, writing to the storage areas stage00 to stage31 is not performed. The internal state signals stage00[3:0] to stage31[3:0] are maintained as the internal state signals 1001. The oldest internal state signal of “4” is stored in the storage area stage31, and the latest internal state signal of “9” is stored in the storage area stage00.

At the time t2, the write enable signal EN changes from being asserted to being negated. The monitor circuit 112 outputs the internal state signals 1001, and the control register 113 stores the internal state signals 1001.

As above, the monitor circuit 112 stores “0” of the internal state signal as well as the preceding seven internal state signals and the subsequent 24 internal state signals in the storage areas stage00 to stage31, and outputs them to the control register 113, like the internal state signals 1001.

As illustrated in FIG. 5 to FIG. 10, the monitor circuit 112 changes the method of writing to the FIFO buffer 123 according to the mode signal MD[2:0].

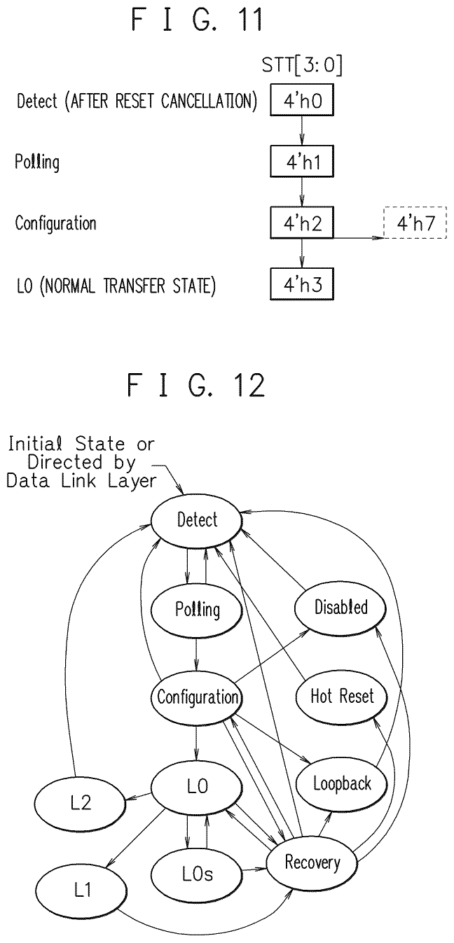

FIG. 11 is a view illustrating an example of changes of the internal state signal STT[3:0], and FIG. 12 is a state transition diagram of an LTSSM. In a normal operation, for example, the internal state signal STT[3:0] undergoes a state transition of “0”→“1”→“2”→“3.” Here, as illustrated in FIG. 2, for example, “2” represents the Configuration state. “3” represents the normal transfer state (L0). The left part in FIG. 11 corresponds to the states in FIG. 12.

In an abnormal operation, for example, the internal state signal STT[3:0] does not transition from “2” to “3,” but transitions from “2” to “7.” In this case, in FIG. 12, the state transitions from “Configuration” to “Disabled.” There is explained an example where debugging such an abnormal state is performed.

In such a case, the CPU 102 writes the trigger state signal FMS[10:0] illustrated in FIG. 13 to the control register 113. Of the trigger state signal FMS[10:0], the bit corresponding to the internal state signals of “0,” “1,” “2,” and “3” in the normal operation in FIG. 11 is “0,” and the bit of the others is “1.” Further, the CPU 102 sets the mode signal MD[0] to “1” and sets the monitor circuit 112 to the trigger mode on state.

Then, when the internal state signal STT[3:0] in the normal operation in FIG. 11 is input, the monitor circuit 112 does not stop writing to the FIFO buffer 123, but when any other internal state signal STT[3:0] is input, the monitor circuit 112 stops writing to the FIFO buffer 123.

For example, when the internal state signal STT[3:0] of “7” in the abnormal operation is written to a designated storage area of the FIFO buffer 123, the monitor circuit 112 stops writing to the FIFO buffer 123.

At this time, the internal state signals stage00[3:0] to stage31[3:0] including “7” are stored in the control register 113, and a FIFO state signal FS[1] becomes “1.” The case where the FIFO state signal FS[1] is “1” indicates that an internal state other than the internal states in the normal operation in FIG. 11 (for example, “7”) has been stored in a designated storage area of the FIFO buffer 123. The internal state signals stage00[3:0] to stage31[3:0] stored in the control register 113 are analyzed, thereby enabling debugging of the abnormal state.

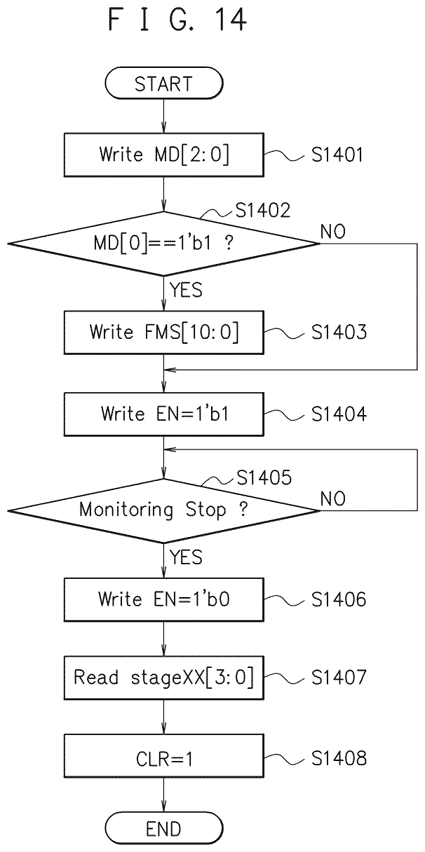

FIG. 14 is a flowchart illustrating an operation example of the semiconductor integrated circuit 100 in FIG. 1. At Step S1401, the CPU 102 writes the mode signal MD[2:0] to the control register 113 via the bus 106. Incidentally, the external device may also write the mode signal MD[2:0] to the control register 113 via the debugging terminal 107.

At Step S1402, the CPU 102 determines whether or not the mode signal MD[0] is “1.” When the mode signal MD[0] is “1,” the CPU 102 advances the processing to Step S1403, and when the mode signal MD[0] is “0,” the CPU 102 advances the processing to Step S1404.

At Step S1403, the CPU 102 writes the trigger state signal FMS[10:0] to the control register 113 via the bus 106. Incidentally, the external device may also write the trigger state signal FMS[10:0] to the control register 113 via the debugging terminal 107. Thereafter, the processing proceeds to Step S1404.

At Step S1404, the CPU 102 writes the write enable signal EN of “1” indicating assertion to the control register 113 via the bus 106. Incidentally, the external device may also write the write enable signal EN of “1” indicating assertion to the control register 113 via the debugging terminal 107. Thereby, the monitor circuit 112 writes the internal state signal STT[3:0] to the FIFO buffer 123 every time the internal state signal STT[3:0] changes.

The internal state signals stage00[3:0] to stage31[3:0], the write count signal CTR[7:0], and the FIFO state signal FS[1:0] are periodically written to the control register 113 in synchronization with the clock signal.

The CPU 102 or external device can grasp the state of the FIFO buffer 123 being monitored by reading the FIFO state signal FS[1:0] and the write count signal CTR[7:0] from the control register 113.

At Step S1405, the monitor circuit 112 determines whether or not to stop monitoring the internal state signal STT[3:0].

There is explained the case where the mode signal MD[2:0] is “*00.” When the FIFO buffer 123 is full (when the FIFO full signal FL is asserted), the monitor circuit 112 stops writing to the FIFO buffer 123 and advances the processing to Step S1406. Further, when the FIFO buffer 123 is not full, the processing is returned to Step S1405.

There is explained the case where the mode signal MD[2:0] is “*10.” In this case, the processing proceeds to Step S1406 unconditionally.

There is explained the case where the mode signal MD[0] is “1” (namely, the case where the mode signal MD[2:0] is “**1”). When any of the internal state signals indicating the internal state designated by the corresponding bit of the trigger state signal FMS[10:0] being “1” is written to a designated storage area of the FIFO buffer 123, the monitor circuit 112 stops writing to the FIFO buffer 123 and advances the processing to Step S1406. Further, when none of the internal state signals indicating the internal state designated by the corresponding bit of the trigger state signal FMS[10:0] being “1” have been written to the designated storage area of the FIFO buffer 123, the monitor circuit 112 returns the processing to Step S1405.

At Step S1406, the CPU 102 writes the write enable signal EN of “0” indicating negation to the control register 113 via the bus 106. Incidentally, the external device may also write the write enable signal EN of “0” indicating negation to the control register 113 via the debugging terminal 107. When the mode signal MD[2:0] is “*10,” the monitor circuit 112 finishes writing to the FIFO buffer 123 at this timing.

At Step S1407, the CPU 102 reads the internal state signals stage00[3:0] to stage31[3:0] from the control register 113 via the bus 106. Incidentally, the external device may also read the internal state signals stage00[3:0] to stage31[3:0] from the control register 113 via the debugging terminal 107. The internal state signals stage00[3:0] to stage31[3:0] are analyzed, thereby enabling debugging.

At Step S1408, the CPU 102 writes the clear signal CLR of “1” to the control register 113 via the bus 106. Incidentally, the external device may also write the clear signal CLR of “1” to the control register 113 via the debugging terminal 107. The initial value of the clear signal CLR is “0.”

When the clear signal CLR becomes “1,” the FIFO buffer 123 initializes the storage areas stage00 to stage31 to a predetermined value, which is all 1's or the like, and the write counter 402 initializes the write count signal CTR[7:0] indicating the write count value to 0.

As above, according to this embodiment, the FIFO buffer 123 can hold a plurality of the time-series internal state signals stage00[3:0] to stage31[3:0], thus making debugging easier.

It is possible to provide a serial data interface circuit that is capable of holding a plurality of time-series internal state signals.

Incidentally, the above-described embodiment merely illustrates concrete examples of implementing the present invention, and the technical scope of the present invention is not to be construed in a restrictive manner by the embodiment. That is, the present invention may be implemented in various forms without departing from the technical spirit or main features thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An interface circuit, comprising:
a transmission and reception circuit being a circuit configured to transmit and receive serial data, the transmission and reception circuit having a plurality of internal states, the transmission and reception circuit configured to operate by performing a state transition between a plurality of the internal states;
a control circuit configured to output, in time-series order, an internal state signal that indicates a current internal state among the plurality of internal states; and
a monitor circuit including a storage circuit having a plurality of storage areas for holding the internal state signals output in time-series order, the monitor circuit configured to monitor an internal state of the transmission and reception circuit, wherein
the monitor circuit is configured to sequentially receive the internal state signal from the control circuit and write the received internal state signal to the plurality of storage areas in time-series order.

2. The interface circuit according to claim 1, wherein
the storage circuit is a FIFO buffer configured to perform first-in, first-out for the internal state signals.

3. The interface circuit according to claim 1, further comprising:
a control register configured to store a control signal for controlling an operation of the monitor circuit, wherein
the monitor circuit is configured to write the internal state signal to the storage circuit based on the control signal stored in the control register.

4. The interface circuit according to claim 1, wherein
the monitor circuit is configured to write, each time the internal state signal changes, the changed internal state signal to the storage circuit.

5. The interface circuit according to claim 1, wherein
the monitor circuit is configured to control writing to the storage circuit based on a write enable signal.

6. The interface circuit according to claim 5, wherein
the storage circuit is a FIFO buffer configured to perform first-in, first-out for the internal state signals, and
the monitor circuit is configured to start writing to the FIFO buffer when the write enable signal is asserted, and finish writing to the FIFO buffer when the FIFO buffer becomes full.

7. The interface circuit according to claim 5, wherein
the monitor circuit is configured to start writing to the storage circuit when the write enable signal is asserted, and finish writing to the storage circuit when the write enable signal is negated.

8. The interface circuit according to claim 1, wherein
the monitor circuit is configured to finish writing to the storage circuit when the internal state signal indicating a designated internal state is written to a designated storage area among the plurality of storage areas.

9. The interface circuit according to claim 8, wherein
the monitor circuit is configured to start writing to the storage circuit when a write enable signal is asserted.

10. The interface circuit according to claim 1, wherein
the monitor circuit is configured to finish writing to the storage circuit when any of a plurality of the internal state signals, each of which indicates a designated internal state, is written to a designated storage area among the plurality of storage areas.

11. The interface circuit according to claim 1, wherein
the storage circuit is a FIFO buffer configured to perform first-in, first-out for the internal state signals, and
the monitor circuit is configured to finish writing to the FIFO buffer when the internal state signal indicating a designated internal state is written to a first-stage storage area among the plurality of storage areas.

12. The interface circuit according to claim 1, wherein
the storage circuit is a FIFO buffer configured to perform first-in, first-out for the internal state signals, and
the monitor circuit is configured to finish writing to the FIFO buffer when the internal state signal indicating a designated internal state is written to a final-stage storage area among the plurality of storage areas.

13. The interface circuit according to claim 1, wherein
the storage circuit is a FIFO buffer configured to perform first-in, first-out for the internal state signals, and
the monitor circuit is configured to finish writing to the FIFO buffer when the internal state signal indicating a designated internal state is written to an intermediate-stage storage area between a first stage and a final stage among the plurality of storage areas.

14. The interface circuit according to claim 1, wherein
the monitor circuit includes a write counter configured to count a number of times of writing to the storage circuit.

15. The interface circuit according to claim 14, wherein
the storage circuit is a FIFO buffer configured to perform first-in, first-out for the internal state signals, and
the write counter is configured to output a signal indicating whether or not the FIFO buffer is full.

16. The interface circuit according to claim 10, further comprising:
a register configured to store a signal that sets the designated internal states from among the plurality of internal states.

17. The interface circuit according to claim 1, further comprising:
a register configured to store the internal state signals held in a plurality of the storage areas.

18. The interface circuit according to claim 1, wherein
the monitor circuit is configured to change a method of writing to the storage circuit according to a mode signal.

19. A semiconductor integrated circuit, comprising:
an interface circuit; and
a processing circuit configured to control transmission and reception via the interface circuit, wherein
the interface circuit includes:
a transmission and reception circuit being a circuit configured to transmit and receive serial data, the transmission and reception circuit having a plurality of internal states, the transmission and reception circuit configured to operate by performing a state transition between a plurality of the internal states;
a control circuit configured to output, in time-series order, an internal state signal that indicates a current internal state among the plurality of internal states; and
a monitor circuit including a storage circuit having a plurality of storage areas for holding the internal state signals output in time-series order, the monitor circuit configured to monitor an internal state of the transmission and reception circuit, and
the monitor circuit is configured to sequentially receive the internal state signal from the control circuit and write the received internal state signal to the plurality of storage areas in time-series order.

20. The semiconductor integrated circuit according to claim 19, wherein
the monitor circuit is configured to finish writing to the storage circuit when the internal state signal indicating a designated internal state is written to a designated storage area among the plurality of storage areas.
